(19) United States
(12) Patent Application Publication
(10) Pub. No.: US 2026/0361325 A1
(43) Pub. Date: Nov. 12, 2026

(54) MULTI-BAND RADIO-FREQUENCY TRANSCEIVERS

(71) Applicant: Nordic Semiconductor ASA, Trondheim (NO)

(72) Inventors: Arne NETTUM, Trondheim (NO); Tor Øyvind VEDAL, Trondheim (NO)

(73) Assignee: Nordic Semiconductor ASA, Trondheim (NO)

(21) Appl. No.: 19/559,193

(22) Filed: Mar. 6, 2026

(30) Foreign Application Priority Data
May 12, 2025 (GB) 2507251.3

(51) Int. Cl. H04B 1/00; H04B 1/40

(52) U.S. Cl. CPC H04B 1/006; H04B 1/40

(57) ABSTRACT

A radio transceiver for supporting multiple radio-frequency bands comprises an analog front-end portion, a reference oscillator, a fractional phase-locked-loop configured to receive a first reference signal from the reference oscillator, and an integer phase-locked-loop. The analog front-end portion supports a first radio-frequency band and a second radio-frequency band. The transceiver is configured to be operable in a first mode and a second mode of operation. The first mode of operation comprises the fractional phase-locked-loop providing a first signal to the analog front-end. The second mode of operation comprises the fractional phase-locked-loop providing a second signal to the integer phase-locked-loop as a second reference signal. The integer phase-locked-loop is configured to scale the second reference signal by an integer value to produce a scaled signal, and to output the scaled signal to the analog front-end portion.

### CROSS-REFERENCE TO RELATED APPLICATION

This application claims priority from United Kingdom Patent Application No. 2507251.3, filed May 12, 2025, which application is incorporated herein by reference in its entirety.

### FIELD

This invention relates to radio transceivers which can support multiple radio-frequency bands.

### BACKGROUND OF THE INVENTION

Radio devices communicate wirelessly by transmitting radio-frequency (RF) signals on a carrier wave, which can be modulated to encode data. The frequency of the carrier wave falls within a specific range of frequencies called a band. In current Bluetooth enabled radio devices, for example, the 2.4 GHz band is used, which ranges from 2.4 to 2.5 GHz. When a radio device is listening for incoming radio signals, it listens on the range of frequencies specified by the band. Since radio communication for a given radio device is performed within a specific band supported by the device, congested environments where there are many radio devices in a small area operating on the same band can lead to bandwidth challenges. In the case of Bluetooth devices, this is becoming an increasingly relevant issue, as more and more devices are operating within the same comparatively narrow frequency band, and manufacturers are seeking to mitigate this issue.

One proposed way to increase bandwidth is to provide a radio device which is able to support transmission and reception on more than one band. For example, Bluetooth devices could be configured to support a 5GHz band or a 6 GHz band in addition to the 2.4 GHz band required by existing Bluetooth standards. However, in order to support additional bands, the hardware used to transmit and receive radio signals needs to be considered. In particular, some approaches consider how phase-locked-loop (PLL) circuits are applied, which are used as frequency synthesisers.

Conventional approaches for supporting more than one frequency band involve either using a shared PLL which can support all targeted bands, or using separate PLLs for each band. Both of these approaches have significant disadvantages. Using a shared PLL introduces complexity, and therefore cost, in construction, and results in a PLL which is not sufficiently optimised for each band, leading to an increase in power consumption. Separate PLLs for each band is more costly in terms of silicon area, particularly for polar transmitter architectures, which must generate the RF carrier signals and apply a phase modulation.

The present invention seeks to mitigate present shortcomings in supporting additional RF bands.

### SUMMARY OF THE INVENTION

From a first aspect, the invention provides a radio transceiver for supporting multiple radio-frequency bands, the radio transceiver comprising:
an analog front-end portion supporting a first radio-frequency band and a second radio-frequency band; a reference oscillator;
a fractional phase-locked-loop configured to receive a first reference signal from the reference oscillator; and
an integer phase-locked-loop;

wherein the transceiver is configured to be operable in a first mode and a second mode of operation, the first mode of operation comprising the fractional phase-locked-loop providing a first signal to the analog front-end portion and the second mode comprising the fractional phase-locked-loop providing a second signal to the integer phase-locked loop as a second reference signal;

wherein the integer phase-locked-loop is configured to scale the second reference signal by an integer value to produce a scaled signal, and to output the scaled signal to the analog front-end portion.

Thus it will be seen that, in accordance with the invention, by using the combination of a fractional phase-locked-loop (PLL) which provides the carrier wave to the analog frontend for supporting a first RF band, and an integer PLL which can instead receive the output from the fractional PLL and scale it up for use by the analog front-end for supporting a second RF band, the radio circuitry as a whole can more support multiple RF bands. This arrangement can be more efficient compared to traditional approaches, while maintaining optimised support for the first RF band, which is typically the most used band.

More specifically the Applicant has recognised that the fractional PLL can operate as before, generating the different frequencies needed to support all the channels in the lower band by scaling up the relatively low reference frequency from a reference oscillator such as a crystal. On the other hand, the integer PLL is only required, in the second mode, to perform the more straightforward operation of scaling the high frequency signal received from the fractional PLL such that it is suitable for the additional RF band. Such an integer PLL can typically be of a much simpler design compared to a fractional PLL, so that it can take up less silicon area and need less power to run. The fractional PLL can therefore remain optimised for the first RF band, and does not need to have further complexity to provide the ability to support additional RF bands. The radio transceiver may therefore advantageously use less power, and take up less silicon area to support additional RF bands, compared to conventional approaches.

The approach set out above contrasts with conventional approaches which either use a complicated wide-range PLL to dynamically switch which carrier wave band it is generating, which is costly in terms of power efficiency and may also compromise performance; or provide individual PLLs for each RF band, which takes up a lot of silicon area.

In some embodiments, the first mode of operation comprises the fractional phase-locked-loop providing the first signal for the first radio-frequency band, and the integer phase-locked-loop providing the scaled signal for the second radio-frequency band.

Whilst it may be useful to have a single analog front-end portion, for example in some applications where the two RF bands are relatively close in frequency, the Applicant has recognised that more generally it may be beneficial to have a dedicated analog front-end portion for each RF band. Thus when viewed from another aspect the invention provides a radio transceiver for supporting multiple radio-frequency bands, the radio transceiver comprising:
a first analog front-end portion supporting a first radio-frequency band;
a second analog front-end portion supporting a second radio-frequency band;
a reference oscillator;
a fractional phase-locked-loop configured to receive a first reference signal from the reference oscillator; and
an integer phase-locked-loop;

wherein the transceiver is configured to be operable in a first mode and a second mode of operation, the first mode of operation comprising the fractional phase-locked-loop providing a first signal to the first analog front-end portion and the second mode comprising the fractional phase-locked-loop providing a second signal to the integer phase-locked loop as a second reference signal;

wherein the integer phase-locked-loop is configured to scale the second reference signal by an integer value to produce a scaled signal, and to output the scaled signal to the second analog front-end portion.

The analog front-end portion(s) contain circuitry which allows the radio transceiver to transmit and receive radio signals within the frequency range of a particular RF band. When transmitting, the front-end portion(s) receive the carrier wave from the selected PLL, modulate and amplify it, and provide the amplified transmission signal to an antenna for transmission. Thus, the analog front-end portion(s) may comprise a respective transmission power amplifier and a respective antenna, with the respective transmission power amplifier being connected to the respective antenna. Each antenna may also be connected to a respective receive low noise amplifier, in order to amplify signals received by the radio transceiver on the particular RF band. Thus, the analog front-end portion(s) may also comprise a respective receive low noise amplifier connected to the respective antenna. The front-end portion(s) may also comprise other components, such as filters, current sources, etc. as necessary.

In some embodiments, the second signal is a fractional value of the first signal. This may be beneficial in achieving the appropriate frequencies from an integer scaling of the (second) signal from the fractional PLL. This may be achieved simply by controlling the divider of the fractional PLL to provide an appropriate division but using the output of the fractional PLL (which in the first mode is provided to the first analog front-end). Alternatively, however the second signal may be provided from the feedback loop of the fractional PLL – e.g. after a fixed or variable divider has been applied to the output of the fractional PLL.

In some embodiments, the radio circuitry can be extended to support more than two RF bands. For example, the radio circuitry may support three RF bands. It may support more than three RF bands. In some embodiments that support more than two RF bands, a further integer PLL is provided to scale the signal from the fractional PLL to the necessary frequency for the specific RF band.

It will be appreciated that the above embodiment can be extended to provide support for any number of further RF bands, e.g. through inclusion of further analog front-end circuitry and a corresponding integer PLL for each added band. However, it is not ruled out that another fractional PLL could be provided – this can still be advantageous over providing say a full fractional PLL for each band.

In some embodiments, the transceiver comprises at least a partial common receive path for the two radio-frequency bands. For example, in embodiments where the radio transceiver comprises a first and a second analog front-end portion, , an output of the first analog front end and an output of the second analog front end may be connected to a primary mixer circuit which receives the first signal from the fractional PLL. In these embodiments, the total silicon area can be further reduced by using the same mixer circuit for all received signals. The output of the primary mixer circuit would typically be connected to an analog-to-digital converter, to provide a digital output in the usual way. One or more filters may be provided between the primary mixer circuit and the analog-to-digital converter.

In embodiments comprising a partially common receive path, the transceiver may comprise a primary and a secondary mixer circuit, wherein the output of the second analog front-end portion is connected to the secondary mixer circuit, and the output of the secondary mixer circuit is connected to the primary mixer circuit. Thus, the secondary mixer circuit may provide an output which is compatible with the components of the primary mixer circuit.

In some embodiments, the frequency of the first signal is in the Gigahertz range, whereas the frequency of the second signal is in the Megahertz range.

In some embodiments, the radio transceiver is provided on an integrated circuit – e.g. a system-on-chip.

In some embodiments, the transceiver supports polar transmission of radio signals. In such embodiments, the fractional PLL is configured to receive a phase modulated signal, and when in the first mode of operation, apply the phase modulation to the first signal, and when in the second mode of operation, apply the phase modulation to the second signal. Thus, by using the fractional PLL to apply phase modulation, the first signal and the second signal also carry the phase modulation. This can be carried forward to the integer PLL, which does not need to apply any phase modulation, since this has already been done by the fractional PLL. The design of the integer PLL can therefore be kept as simple as possible to produce the scaled signal.

In some embodiments, the radio transceiver operates in a mixed mode of operation thereby allowing operation on two bands at the same time, wherein the mixed mode comprises the fractional phase-locked-loop providing the first signal to the first analog front-end portion, and providing the second signal to the integer phase-locked-loop for provision of the scaled signal to the second analog front-end portion. In such embodiments, the first signal may be the same as the second signal. For example, the frequency of the first signal may be 2.4GHz. This may also provide the second signal to be scaled by the integer phase-locked-loop to provide the scaled signal to the second analog front-end portion. In the example where the frequency of the first/second signal is 2.4GHz, the scaled signal may be 7.2GHz (i.e. the integer PLL has scaled by the second signal by a factor of three). Of course, this is only an illustrative example, and any other possible combination of RF bands may be supported by using the radio transceiver according to embodiments of the present invention.

In some embodiments, the radio transceiver is configured to support one or more Bluetooth™ standards. Thus, the first RF band may be a 2.4 GHz band. The second RF band may be a 5 GHz band, or a 6 GHz band. In such embodiments, the integer scaling provided by the integer PLL may be 17, 18, 19, or 20 with the frequency of the fractional PLL being divided by one eighth compared to its normal operation in the 2.4 GHz band – i.e. to 300 MHz. These values of the integer ensure the integer PLL outputs the scaled signal with a frequency within range of the 5/6 GHz band. It will be appreciated that other values may be chosen depending on the frequency range of the second RF band.

The fractional PLL will typically receive a fraction control signal to set a fractional scaling value. The fractional scaling value is used by the fractional PLL to provide the first signal or the second signal with a respective frequency which is an appropriate multiple of the first reference signal. The fractional PLL can therefore adapt the frequency of the first signal and the second signal as needed.

The integer PLL will typically receive an integer control signal. The integer control signal sets the value used by the integer PLL when it scales the second reference signal. The integer PLL can therefore adapt the frequency of the scaled signal as needed.

In some embodiments, the transceiver comprises a frequency control module. The frequency control module may provide the fractional control signal to the fractional PLL and the integer control signal to the integer PLL. The frequency control module may additionally or alternatively provide control signals to switch between the first and second operational modes – i.e. to determine which RF band is being used for transmission or reception.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1A is a block diagram showing radio circuitry supporting two radio-frequency bands according to one conventional implementation;

FIG. 1B is a block diagram showing radio circuitry supporting two radio-frequency bands according to another conventional implementation;

FIG. 2A is a block diagram showing part of a radio transceiver for supporting two radio-frequency bands according to an embodiment of the present invention;

FIG. 2B is a block diagram showing part of a radio transceiver for supporting two radio-frequency bands according to another embodiment of the present invention;

FIG. 3 is a block diagram of the fractional phase-locked-loop circuit used in the embodiments of FIGS. 2A and 2B;

FIG. 4 is a block diagram of the integer phase-locked-loop circuit used in the embodiment of FIGS. 2A and 2B;

FIG. 5 is a block diagram of part of a radio transceiver supporting two radio-frequency bands in a polar transmission scheme according to another embodiment of the present invention; and

FIG. 6 is a block diagram of a polar fractional phase-locked-loop circuit used in the embodiment of FIG. 5.

### DETAILED DESCRIPTION

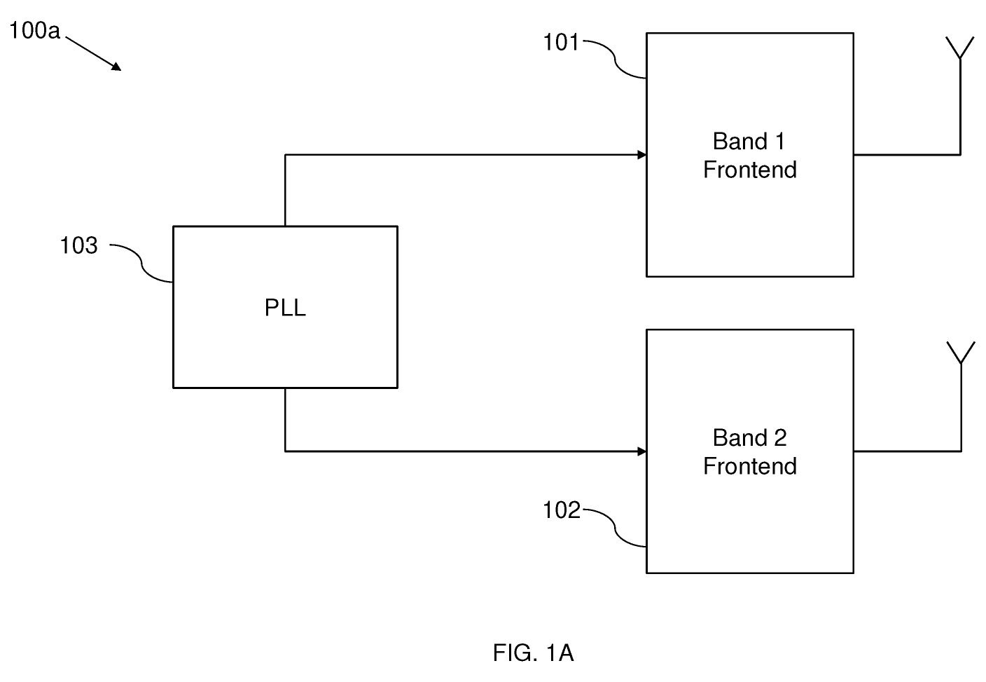

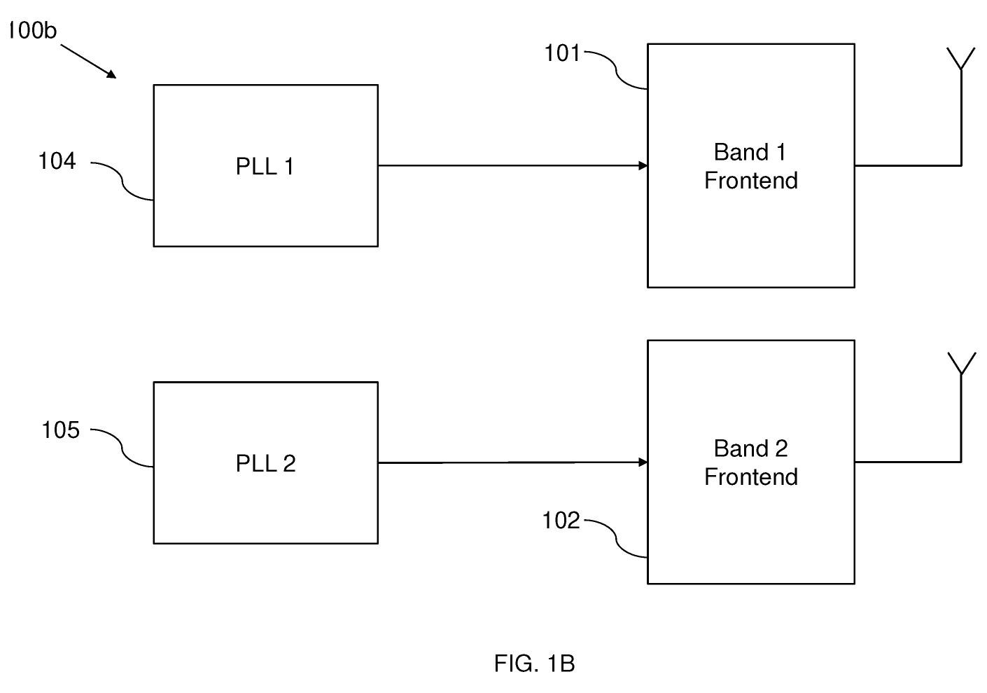

FIG. 1A shows a block diagram of radio circuitry 100a which employs a conventional approach to supporting more than one RF band. The radio circuitry 100a includes an analog front-end portion 101 for a first RF band, and a second analog front-end portion 102 for a second RF band. The first and second analog front-end portions 101, 102 include respective transceiver circuitry for transmitting and receiving radio signals which are within the respective band. For example, the first RF band may be a 2.4 GHz band, and the second RF band may be a 5 GHz radio band. The first analog front-end portion 101 is therefore optimised for transmitting and receiving signals in the 2.4 GHz band, whereas the second analog front-end portion 102 is optimised for transmitting and receiving signals in the 5 GHz band. For simplicity, various amplifiers, filters, mixers, current sources, etc. have been omitted from FIG. 1A, though it will be appreciated by the skilled person that such components or their equivalents would be included in practice.

As will be appreciated by the skilled person, in order for either analog front-end portions 101, 102 to transmit radio signals, a carrier wave of the correct frequency for the particular band needs to be generated. Similarly, in order to receive signals in a particular band, a signal of the correct frequency is required for down-conversion of the received signal. As is well known by those skilled in the art, such signals are generated by a phase-locked-loop (PLL) circuit, which takes a reference frequency (e.g. from a crystal oscillator) as an input, and uses a feedback loop to generate an output signal with a frequency which is proportional to the reference frequency.

In FIG. 1A, a single PLL 103 generates signals for both bands. In order to do this, the PLL 103 needs to be able to dynamically switch the frequency of the output signal depending on which band is in operation. This adds significant complexity to the design of the PLL 103, which leads to increased silicon area and power draw. By trying to balance performance for both bands, the PLL 103 is not optimised for one RF band over another, which leads to further inefficiencies in operation, particularly when there is a preferred band (i.e. a most commonly used band) for operation. For example, if the radio circuitry 100a was used in a Bluetooth device, the preferred band would be the 2.4 GHz band set out in the current Bluetooth standard. Thus, by using the approach of FIG. 1a, overall performance of the 2.4 GHz band would be decreased compared to having a dedicated PLL for the 2.4 GHz band.

Another conventional approach to supporting multiple frequency bands is illustrated by the radio circuitry 100b of FIG. 1B. The radio circuitry 100b includes the same analog front-end portions 101, 102 as FIG. 1A. As with FIG. 1A, various amplifiers, filters, mixers, current sources, etc. have been omitted from the analog front-end portions 101, 102 of FIG. 1B for simplicity. Instead of using a single PLL 103 to provide appropriate frequencies for both bands, the radio circuitry 100b uses dedicated PLLs for each band. A first PLL 104 provides the signal for the first band, and a second PLL 105 provides the signal fir the second analog band. The two PLLs 104, 105 can therefore be optimised for the respective analog bands. However, adding a second dedicated PLL significantly adds to the total silicon area used by the radio circuitry 100b. This issue is exacerbated by transmission architectures which incorporate modulation into the PLL, such as polar transmission architectures. In polar transmission architectures, the PLL generates the carrier wave signal and also implements phase modulation. Supporting phase modulation requires a larger PLL, and so having one PLL per supported RF band will result in radio circuitry that has an even larger silicon area.

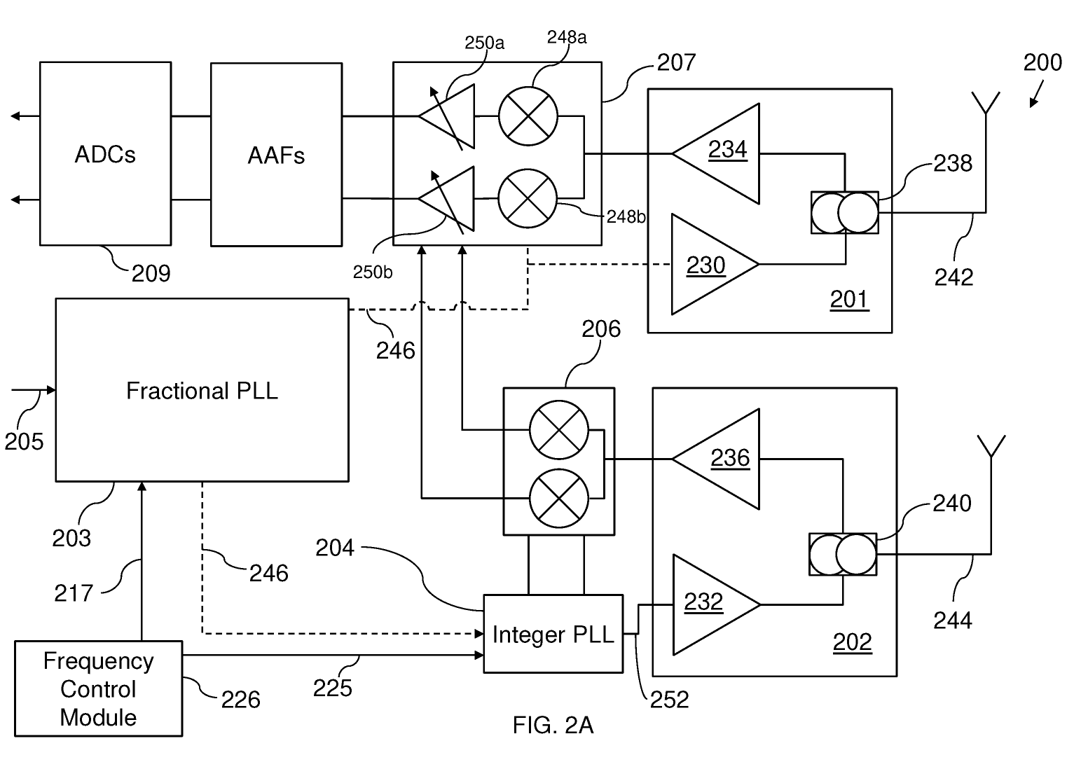

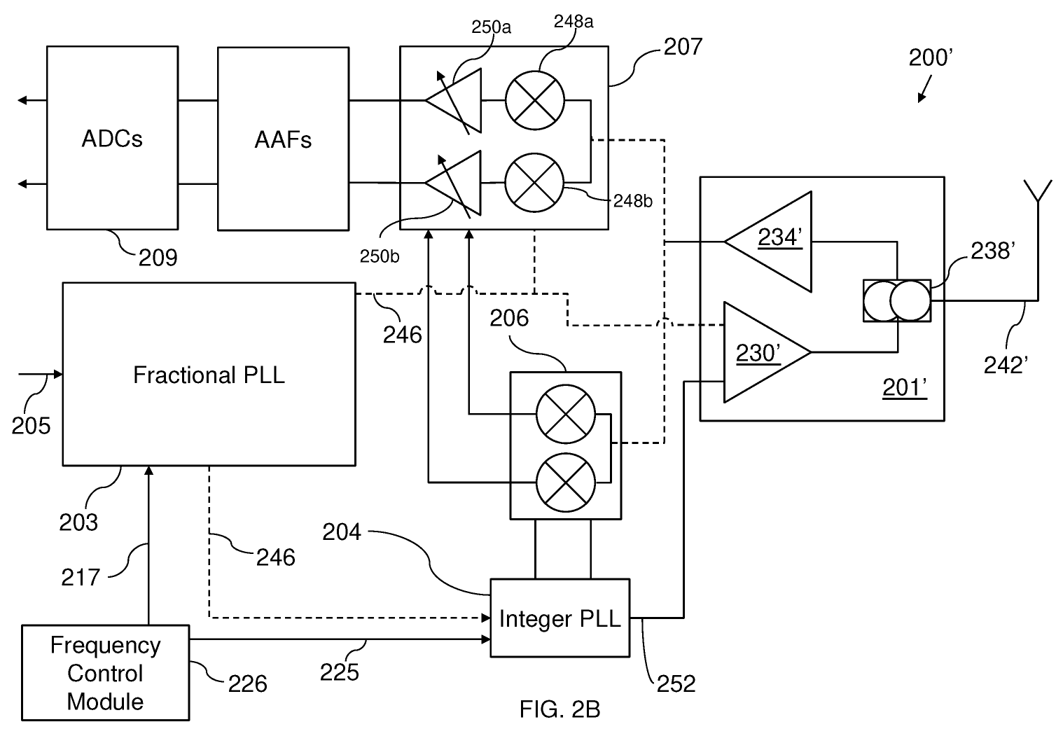

FIG. 2A shows a block diagram of part of a radio transceiver 200 which is capable of supporting multiple RF bands according to one embodiment of the present invention. The radio transceiver 200 shows both the receive and transmit pathways for radio signals. The radio transceiver 200 includes a first analog front-end portion 201, and a second analog front-end portion 202, though it will be appreciated that in other embodiments the radio transceiver has a single analog front-end portion that supports multiple RF bands. The first and second analog front-end portions 201, 202 depicted in FIG. 2A comprise respective power amplifiers 230, 232, low noise amplifiers (LNAs) 234, 236 and impedance matching circuits 238, 240 for the transmit and receive pathways, in addition to an antenna 242, 244. It will be appreciated that the first and second analog front-end portions 201, 202 may also include other components (e.g. additional amplifiers, filters, power connections, etc.) as necessary, but that these have been omitted from FIG. 2A for simplicity. Each analog front-end portion 201, 202 is optimised to support a respective RF band. To be optimised to support an RF bands means that the components of the respective analog front-end portions (i.e. the amplifiers etc.) are designed such that the analog front-end portion can most efficiently transmit and receive radio signals within the specific RF band.

In this embodiment, the first analog front-end portion 201 is optimised to support a 2.4 GHz RF band, whereas the second analog front-end portion 202 is optimised to support a 5 GHz RF band. It will be appreciated that the choice of RF bands in this embodiment is purely exemplary, and that any RF bands could have been chosen. In practice, only one of the first analog front-end portion 201 or the second analog front-end portion 202 will be in operation at any one time (i.e. the radio transceiver 200 will be operating on either the 2.4 GHz band or the 5 GHz band).

The radio transceiver 200 includes a fractional PLL 203 and an integer PLL 204. The fractional PLL 203 receives a first reference signal 205 as an input, which is produced by a reference oscillator, e.g. a 32 MHz crystal oscillator (not shown for simplicity). It will be appreciated that in other embodiments, the first reference signal 205 could be produced by signal sources other than a crystal oscillator. The fractional PLL 203 produces an output signal with a frequency which is a fractional multiple of the frequency of the reference signal 205. The integer PLL 204 produces a scaled signal with a frequency which is an integer multiple of the input reference signal provided – namely from the fractional PLL 203.

In one mode of operation the output 246 of the fractional PLL 203 is provided either to the power amplifier 230 of the first analog front-end portion 201 or to a primary mixer circuit 207, depending on whether the radio is used for transmitting or receiving.

In another mode of operation, the output 246 is provided as a reference signal to the integer PLL 204. The output 252 of the integer PLL 204 (the scaled signal) is similarly either used as an input to the power amplifier 232 of the second analog front-end portion 202 or to a secondary mixer circuit 206. Further details of the fractional PLL 203 and the integer PLL 204 will be provided below.

A frequency control module 226 is also provided and is used to set which RF band the radio transceiver 200 is operating on and which channel is being used within that frequency band. The frequency control module 226 can enable or disable the analog front-end portions and redirect the output 246 of the fractional PLL 203 as necessary. The frequency control module 226 also sends control signals to the fractional PLL 203 and to the integer PLL 204. Specifically, the frequency control module 226 sends a fraction control signal 217 to the fractional PLL 203, and an integer control signal 225 to the integer PLL 204. The nature and purpose of these control signals will be discussed in more detail below.

The output of the first analog front-end portion 201 from the LNA 234 on the receive pathway is connected to the primary mixer circuit 207, which comprises I and Q mixers 248a,b and amplifiers 250a,b in order to down-convert the signals received by the antenna 242 using the signal from the fractional PLL 203. The output of the primary mixer circuitry 207 is connected to a bank of anti-aliasing filters (AAFs) 208, the output of which is passed on to analog-to-digital converters (ADCs) 209. The ADCs 209 convert the analog signals processed by the AAFs 208 and the primary mixer circuitry 207 into digital signals for use by downstream digital components. The output of the ADCs 209 is indicated by the arrows shown in FIG. 2. The combination of the primary mixer circuit 207, the AAFs 208, and the ADCs 209 forms a receive pathway that is followed by signals received by the antenna 242.

The output of the second analog front-end portion 202 is connected to the secondary mixer circuit 206, which is used to down-convert the signals received by the second analog front-end portion 202. The output from the secondary mixer circuit 206 is provided to the amplifiers 250a,b of the primary mixer circuit 207, such that these, the AAFs 208, and the ADCs 209 can be used to process the signals received by the first analog front-end portion 201 and the second analog front-end portion 202. In other words, a partially common receive pathway for the two bands is provided. This minimises the increase in total silicon area required by the radio transceiver 200 to support both bands. As mentioned above, an output from the integer PLL 204 is connected to the secondary mixer circuit 206, in order to provide the correct down-mixing frequency for the mixers of the secondary mixer circuit 206.

FIG. 2B shows a block diagram of part of a radio transceiver 200’ which is capable of supporting multiple RF bands according to another embodiment of the present invention. This is similar to the embodiment for FIG. 2A and indeed like components are depicted with identical reference numerals. However in this embodiment rather than the two respective analog front end portions 201, 202 of FIG. 2A, there is a single, common analog front end portion 201’. As previously the common analog front end portion 201’ comprises a power amplifier 230’, low noise amplifiers (LNA) 234’ and an impedance matching circuit 238 for the transmit and receive pathways, in addition to an antenna 242’. As before analog front-end portion 201’ may also include other components (e.g. additional amplifiers, filters, power connections, etc.) as necessary, omitted from FIG. 2B for simplicity.

In this embodiment the analog front-end portion 201’ designed to support both RF bands corresponding to the outputs of the fractional PLL 203 and the integer PLL 204 respectively. Such an arrangement might be more suitable than that of FIG. 2A for example where the two bands are relatively close to one another and/or where the savings in terms of silicon area that it provides is more important than closely optimising the analog front end for a particular band.

As in the previous embodiment, in one mode of operation the output 246 of the fractional PLL 203 is provided either to the power amplifier 230’ of the analog front-end portion 201’ or to the primary mixer circuit 207, depending on whether the radio is used for transmitting or receiving.

In the other mode of operation, the output 246 is provided as a reference signal to the integer PLL 204, the output 252 of which is similarly either used as an input to the power amplifier 232’ or to the secondary mixer circuit 206. During reception the output of the LNA 234’ is provided either to the primary mixer 207 or the secondary mixer 206 depending on the band in which the analog front end 201’ is operating. This can be controlled by a signal (not shown) from the frequency control module 226.

Of course, it will be appreciated that for transmission, the radio transceiver 200, 200’ will modulate the carrier wave produced by the PLL 203, 204 with transmission data. However, the aspects of the radio transceiver 200, 200’ which provide this functionality have been omitted from FIGS. 2A and 2B for simplicity and clarity.

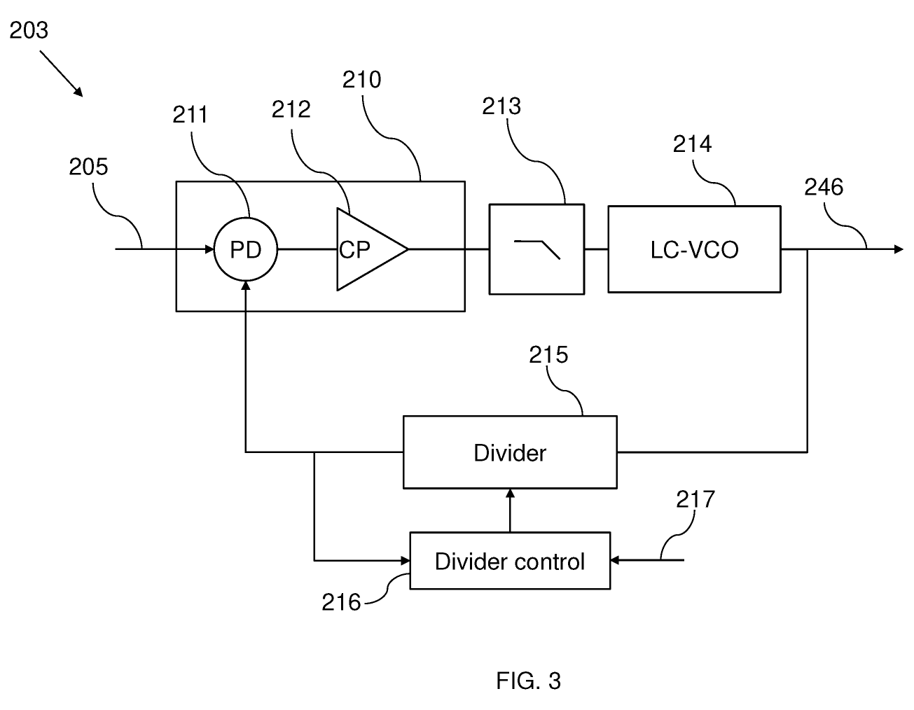

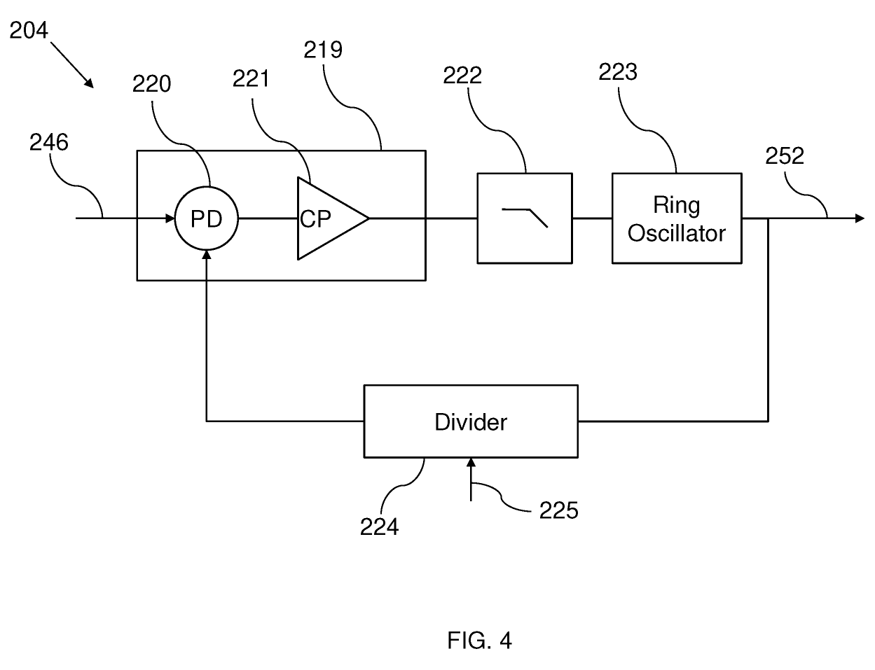

The details of the fractional PLL 203 and the integer PLL 204 will now be discussed with reference to FIGS. 3 and 4.

FIG. 3 shows a block diagram of the fractional PLL 203. The fractional PLL comprises an error detector 210, a low pass filter 213, an inductor-capacitor voltage-controlled oscillator (LC-VCO) 214, a frequency divider 215 and a divider control module 216. The error detector 210 comprises a phase detector 211 and a charge pump 212. The reference signal 205 is provided as an input to the phase detector 211, and the output of the phase detector 211 is connected to the input of the charge pump 212. The output of the charge pump 212 (i.e. the output of the error detector 210) is connected to the low pass filter 213, which is in turn connected to the LC-VCO 214. The output from the LC-VCO 214 is used as the output 246 for the fractional PLL 203, and is also used as part of the feedback loop which is essential to the operation of the PLL 203. Thus, the output 246 from the LC-VCO 214 is also provided to the frequency divider 215, where the frequency of the signal provided by the LC-VCO 214 is divided by a set value which can be a range of different integer or fractional values. The output from the frequency divider 215 is provided as a second input to the phase detector 211, completing the loop.

As is well-known by those skilled in the art, the fractional PLL 203 operates as follows. The phase detector 211 compares the phase of the reference signal 205 and the output of the frequency divider 215. Any difference in phase between these signals is converted into a voltage signal by the charge pump 212, and is used to drive the LC-VCO 214 to produce a signal of a particular frequency. If there is no phase difference, the signal generated by the LC-VCO 214 will not change, allowing for a stable output signal to be produced and used for the generation of RF carrier waves/down-mix signals. If there is a phase difference, then the frequency of the LC-VCO 214 is caused to change such that as the loop operates, the fractional PLL 203 reaches an equilibrium. By setting the appropriate value used by the frequency divider, it will be seen that the LC-VCO 214 can be tuned to produce an output signal with a frequency that is proportional to the reference signal 205.

In order to provide a fractional division (i.e. to produce an output signal from the LC-VCO 214 with a frequency which is a fractional multiple of the frequency of the reference signal 205), the frequency divider 215 changes the dividing value between two values in an alternating manner such that the average is the desired fractional value. To achieve this, the frequency divider 215 is controlled with a control signal provided by a divider control module 216. The divider control module 216 takes two inputs, one of which is the fractional control signal 217 sent by the frequency control module 226, and the other is fed from the output of the frequency divider 215. The fractional control signal 217 specifies what the fractional value should be, and the divider control module 216 uses this, along with the feedback from the output of the frequency divider 215, to send the control signal to the frequency divider 215 to set the value used by the frequency divider 215 to divide the incoming signal from the LC-VCO 214. The divider control module 216 is thus able to dynamically adjust the dividing value used by the frequency divider 215 to achieve a set fractional division of the signal from the LC-VCO 214.

The voltage-controlled oscillator (i.e. the LC-VCO214) used in the fractional PLL 203 is typically sensitive to noise from signals within the sensitivity range of the oscillator. This noise can “pull” the frequency of the signals output from the PLL away from the desired value. To avoid the effects of noise, it is advantageous to run the oscillator at either a completely different frequency to that needed as the output, or at exactly the same frequency. The LC-VCO 214 of the fractional PLL 203 described above is configured to run at exactly the frequency needed.

FIG. 4 shows a block diagram of the integer PLL 204. The integer PLL 204 also comprises an error detector 219, a low pass filter 222 and a frequency divider 224. However in this module a different oscillator can be used such as a ring oscillator 223. The high frequency, low-noise reference signal from the fractional PLL enables better noise correction of the oscillator used in the integer PLL, enabling simpler oscillators to be used, such as the ring oscillator 223. This can save silicon area in the integer PLL. Similarly, a simple integer divider 224 controlled by an integer control signal 225 is provided which takes up less silicon area than the fractional divider 215 shown in FIG. 2.

The error detector 219 comprises a phase detector (labelled PD in FIG. 4) 220, and a charge pump (labelled CP in FIG. 4) 221, which operate in the same way as the phase detector 211 and charge pump 212 of the fractional PLL 203 shown in FIG. 3.

The integer PLL 204 receives a reference signal 246 from the fractional PLL 203 as shown in FIG. 2. This is scaled up to the correct frequency band by setting the appropriate value of the integer control signal to provide an output signal 252 which is provided either to the power amplifier 232 of the second analog front-end portion 202 or to the secondary mixer module 206 depending on whether the radio is transmitting or receiving.

As the integer PLL 204 has a far simpler design compared to the fractional PLL 203, and as a result is less power demanding, and takes up less silicon area.

Referring back to FIG. 3, it can be seen that the radio transceiver 200 can more efficiently support two different RF bands compared to conventional approaches in the following manner. The frequency control module 226 sets which RF band the radio transceiver 200 operates on. In the case of the first RF band being used, the controller 226 diverts the output 246 of the fractional PLL to the first analog front-end portion 201 or the primary mixer 207 and provides a fractional control signal 217 appropriate for desired channel in the first RF band to the fractional PLL 203. The fractional PLL 203 receives the first reference signal 205 and the fractional control signal 217 and generates a first signal with a frequency which is compatible with the first band. As mentioned above, if the first RF band supported by the first analog front-end portion 201 is a 2.4 GHz band, then the frequency of the signal output from the fractional PLL 203 will be within the range of the 2.4 GHz band. The fractional PLL 203 is able to generate all of the required channels (due to the ability to scale the reference signal 205 by a fractional amount), and thus the behaviour of the fractional PLL 203 with the first analog front-end portion 201 is no different to an implementation where a PLL is dedicated to the first analog front-end portion 201 (analogous to the scenario illustrated in FIG. 2).

In the case where the radio transceiver 200 is operating on the second RF band, the frequency control module 226 diverts the output 246 of the fractional PLL to the second analog front-end portion 202.

By providing a suitable fractional control signal 217 to the fractional PLL 203 and integer control signal 225 to the integer PLL 204, the latter can generate an output 252 which is the correct frequency for the desired channel in the higher, second RF band. In this example, since the first RF band is 2.4 GHz, and the second RF band is 5 GHz, then an integer multiple of 2.4 GHz does not produce a frequency which is appropriate for the second RF band. Thus, the fractional control signal 217 is used to cause the fractional PLL 203 to generate a signal 246 with a frequency which is one eighth of this i.e. 300 MHz. Based on the integer control signal 225 from the frequency control module 226, the integer PLL 204 scales this signal up based on the value set at the frequency divider 224. This will produce a scaled signal at the output 252 of the integer PLL 204. As mentioned above, the second RF band, in this example, is a 5 GHz band, and the frequency of the second signal output from the fractional PLL is 300 MHz. Thus, the integer control signal 225 output from the frequency control module 226 will set the integer value used by the frequency divider 224 to be either 17, 18, 19, or 20 depending on the required channel frequency. Scaling the 300 MHz input by one of these integer values allows the integer PLL 204 to produce an output 252 with a frequency of 5.1 GHz, 5.4 GHz, 5.7 GHz, or 6 GHz depending on the selected value. Any of these frequencies are in the correct range for the second RF band. The scaled signal can therefore be output to the second analog front-end portion 202 or to the secondary mixer circuit 206.

Thus it will be seen that by using the high frequency signal generated by the fractional PLL 203 as a reference signal, the integer PLL 204 is able to scale the second signal up with a relatively low loop frequency gain to the frequency required by the second RF band, without the need for extra circuitry to generate such a frequency from scratch. The high frequency of the reference 246 allows the noise requirements for the components of the integer PLL 204 to be greatly relaxed, since most of the effects of noise have been accounted for by the fractional PLL 203, meaning that a simple design can be used.

Since the integer PLL 204 is much simpler in its design compared to the fractional PLL 203, the overall silicon area taken by adding in the integer PLL 204 is much less than if a separate dedicated PLL was used to support the second RF band. In one example implementation of the invention, adding circuitry to support the second RF band (i.e. the second analog front-end portion 202 and the integer PLL 204) only increases silicon area of the radio transceiver 200 by 30 percent. If a separate dedicated PLL was used instead (i.e. another fractional PLL), the silicon area would almost double. In addition, the simple nature of the integer PLL 204 results in a reduced additional power draw for the second RF band, which is particularly advantageous when the radio transceiver 200 is a low power radio device.

In addition, the radio transceiver 200 has many components in common with a design for a radio transceiver which supports only a single RF band. In particular, as described, the fractional PLL 203, the first analog front-end portion 201, the primary mixer circuit 207, the AAFs 208 and the ADCs 209 can work together to support the first RF band as though the integer PLL 204 and second analog front-end portion 202 were not present. This allows the functionality of the radio transceiver 200 to be added to existing radio transceiver designs without requiring a complete redesign. Indeed, if the first RF band is needed, then the second analog front-end portion 202, the integer PLL 204, and the secondary mixer circuit 206 need not be used, without any performance impact on the first RF band.

Since the fractional PLL 203 and the integer PLL 204 can be adjusted by the frequency control module 226, the second analog front-end portion 202 could be used to support another RF band, different to the first or second RF band mentioned previously. To support this further band, the fractional value set for the fractional PLL 203 and the integer value set for the integer PLL 204 needs to be adjusted such that the scaled signal output by the integer PLL 204 has the desired frequency. For example, with a hypothetical third RF band operating at 7 GHz, the fractional value might be the same (e.g. one eighth to produce a 300 MHz output signal), whereas the integer value might be 24 such that the integer PLL 204 produces a scaled signal with a frequency of 7.2 GHz.

The above discussion describes a radio transceiver 200 which can support multiple RF bands when the PLL is only required to generate the frequency of the carrier wave for transmission or down-mixing. In other transmission architectures, such as polar architectures, the PLL must apply phase modulation to the generated carrier wave. The principles behind the radio transceivers 200, 200’ of FIGS. 2A and 2B allow for additional advantages for radio transceivers which support polar transmission.

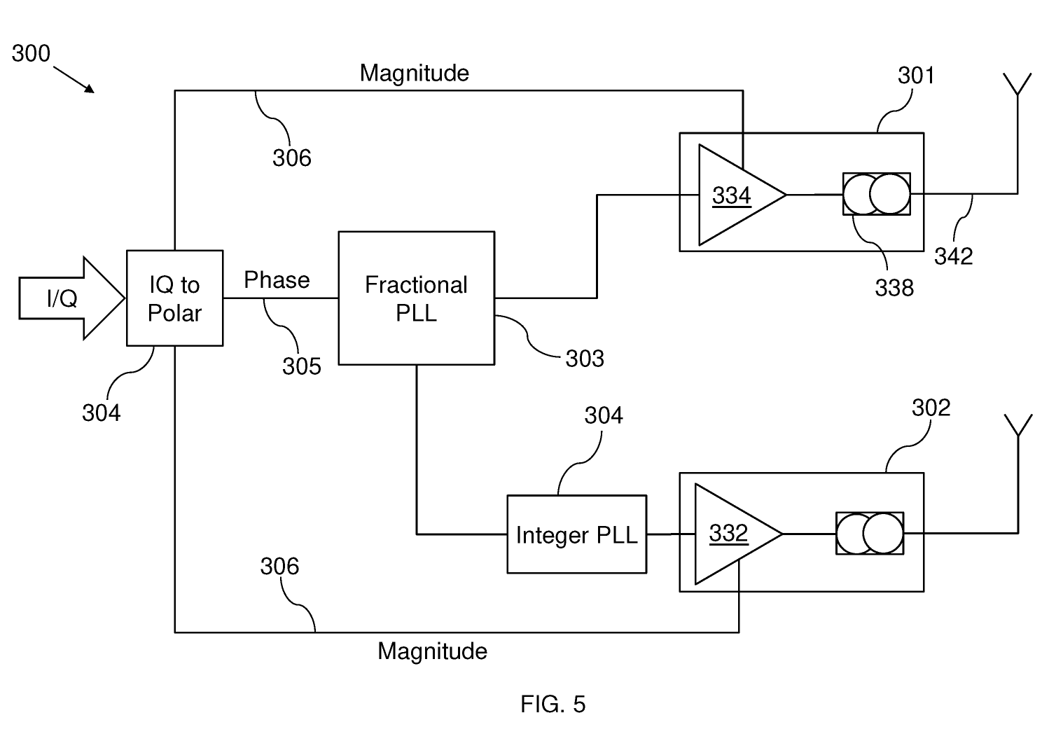

FIG. 5 shows part of a radio transceiver 300 which is able to support multiple RF bands with a polar transmission scheme. For simplicity, the radio transceiver 300 in FIG. 3 only shows the transmission path for radio signals, since the receive pathway is largely the same as that shown in FIG. 2. The radio transceiver 300 includes a first analog front-end portion 301 and a second analog front-end portion 302. These analog front-end portions are similar to the analog front-end portions described with relation to FIG. 2, but have been simplified in FIG. 3 to only show the power amplifier 334, the impedance matching circuit 338, and the antenna 342. The radio transceiver 300 includes a polar fractional PLL 303, and an integer PLL 304 which operates in the manner described with reference to FIGS. 2A, 2B, and 4 above. In addition to the analog front-end portions and the PLLs, the radio transceiver 300 includes a converter module 304. The converter module 304 receives the in-phase (I) and quadrature (Q) components of modulation transmission data (shown by the arrow labelled “I/Q” in FIG. 5), and converts these components into magnitude and phase components required for polar transmission. The magnitude component can be carried directly to the respective power amplifier of each analog front-end portion. With reference to FIG. 5, the magnitude component 306 is carried from the converter module 304 to the power amplifier of the first analog front-end portion 301, and to the power amplifier of the second analog front-end portion 302 (shown by the lines labelled “Magnitude”). The phase component 305 (also labelled “Phase” in FIG. 5) is carried to the polar fractional PLL 303. For simplicity, the reference signal (e.g. similar to the first reference signal 205 used by the fractional PLL 203) which provides a reference frequency to the polar fractional PLL 303 has been omitted, though the polar fractional PLL 303 still receives a reference frequency from a reference oscillator such as a crystal oscillator.

The output from the polar fractional PLL 303 is connected to the first analog front-end portion 301, and to the integer PLL 304. The output from the integer PLL 204 is connected to the input of the power amplifier 332 second analog front-end portion 302.

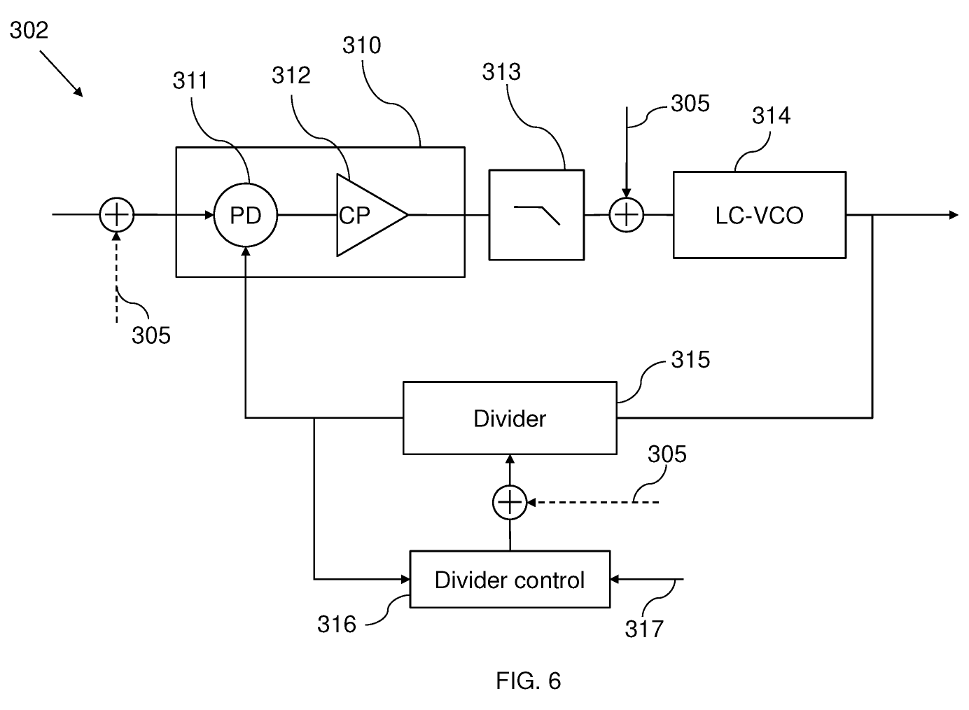

The integer PLL 204 has the same structure and function as described with relation to FIGS. 2 and 4. The integer PLL 304 thus receives a reference signal from the polar fractional PLL 303, and scales it up by an integer amount to produce a scaled signal for use by the second analog front-end portion 302. The operation of the polar fractional PLL 303 will be described with reference to FIG. 6.

FIG. 6 shows a breakdown of the components of the polar fractional PLL 303. The polar fractional PLL 303 has many of the same components as that of the fractional PLL 203 described with reference to FIGS. 2 and 3. In particular, the polar fractional PLL 303 comprises an error detector 310 (and the phase detector 311 and the charge pump 312 therein), a low pass filter 313, a LC-VCO 314, a frequency divider 315 and a divider control module 316. The divider control module 316 receives a fraction control signal 317 as previously described with reference to the first embodiment.

However, there are some structural differences compared to the fractional PLL 203 of the first embodiment, which enables the polar fractional PLL 303 to handle phase modulation, as is necessary for polar transmission. The phase modulated signal 305 is introduced to the polar fractional PLL 303 at two locations to provide “two-point modulation”. The first location is between the low pass filter 313 and the LC-VCO 314, where the phase modulation is introduced as an additional voltage signal combined with the voltage output from the low pass filter 313 to the LC-VCO 314. The second location is either between the divider control module 316 and the frequency divider 315 or the input to the error detector 310. These are indicated by the dashed arrows in FIG. 6. Applying the phase modulation at the second location allows for the value set at the frequency divider 315 to be constantly updated in order to follow the changing modulation, otherwise the modulation would be filtered and distorted by the PLL loop bandwidth. By applying the phase modulation at both the first and second locations, the loop bandwidth of the polar fractional PLL 303 does not restrict the bandwidth of the modulation, thereby enabling modulated signal bandwidths larger than the PLL bandwidth itself. In some embodiments, the phase modulation may be applied at only the second location, though the modulated signal bandwidth cannot be larger than the loop bandwidth of the polar fractional PLL 303.

With these structural changes, the polar fractional PLL 303 is able to produce output signals which can not only have a frequency which is a fractional multiple of the first reference frequency, but also encodes the phase modulation provided from the converter module 304. Thus, when the radio transceiver 300 is operating to support the first RF band, the first analog front-end portion 301 will be active, and the polar fractional PLL 303 outputs a first signal which has a frequency in the range of the first RF band, and also encodes the phase modulation needed for polar transmission.

When the radio transceiver 300 is operating to support the second RF band, the second analog front-end portion 302 will be active, and the polar fractional PLL 303 outputs a second signal which has a frequency in the range of the second RF band, and also encodes the phase modulation needed for polar transmission. Thus, the integer PLL 304 is able to produce a scaled signal which is not only the desired frequency for the second RF band, but also encodes the phase modulation. This is despite the fact that the integer PLL 304 does not have any additional circuitry needed to apply the phase modulation. Instead, the phase modulation is passed through from the polar fractional PLL 303. Introducing the phase modulation at the fractional PLL allows the integer PLL 244 to remain simple, keeping power draw low and avoiding any further addition to the total silicon area of the radio transceiver 300.

Since the frequency of the second signal output from the polar fractional PLL 303 will typically be in the hundreds of megahertz range, the bandwidth of the integer PLL 304 can be high enough to support the modulation carried by the second signal. As mentioned above, the high frequency of the second signal allows the noise requirements for the components of the integer PLL 304 to be greatly relaxed.

It is important to note that the radio circuitry 300 described above also applies to polar transmission schemes operating with “constant envelope formats”, where the magnitude component is not necessary (e.g. in Bluetooth Low Energy). In such cases, the magnitude component is not passed on to the power amplifiers of the analog front-end portions, since the magnitude will be a constant value.

It will be appreciated by those skilled in the art that the invention has been illustrated by describing one or more specific embodiments thereof, but is not limited to these embodiments; many variations and modifications are possible, within the scope of the accompanying claims.

1. A radio transceiver for supporting multiple radio-frequency bands, the radio transceiver comprising:
an analog front-end portion supporting a first radio-frequency band and a second radio-frequency band;
a reference oscillator;
a fractional phase-locked-loop configured to receive a first reference signal from the reference oscillator; and
an integer phase-locked-loop;
wherein the transceiver is configured to be operable in a first mode and a second mode of operation, the first mode of operation comprising the fractional phase-locked-loop providing a first signal to the analog front-end portion and the second mode comprising the fractional phase-locked-loop providing a second signal to the integer phase-locked loop as a second reference signal;
wherein the integer phase-locked-loop is configured to scale the second reference signal by an integer value to produce a scaled signal, and to output the scaled signal to the analog front-end portion.

2. The radio transceiver as claimed in claim 1, wherein the second signal is a fractional value of the first signal.

3. The radio transceiver as claimed in claim 1, comprising a common partial receive path for the first and second radio-frequency bands.

4. The radio transceiver as claimed in claim 1, wherein
the radio transceiver is provided on an integrated circuit.

5. The radio transceiver as claimed in claim 1, wherein the transceiver supports polar transmission of radio signals.

6. The radio transceiver as claimed in claim 5, wherein the fractional phase locked loop is configured to:
i) receive a phase modulated signal;
ii) when in the first mode of operation, to apply the phase modulation to the first signal; and
iii) when in the second mode of operation, to apply the phase modulation to the second signal.

7. The radio transceiver as claims in claim 1, further comprising:
a first analog front-end portion supporting a first radio-frequency band; and
a second analog front-end portion supporting a second radio-frequency band.

8. The radio transceiver as claimed in claim 7, configured to operate in a mixed mode of operation, the mixed mode comprising the fractional phase-locked-loop providing the first signal to the first analog front-end portion, and providing the second signal to the integer phase-locked-loop for provision of the scaled signal to the second analog front-end portion.

9. The radio transceiver as claimed in claim 7, comprising a primary and a secondary mixer circuit, wherein the output of the second analog front-end portion is connected to the secondary mixer circuit and the output of the secondary mixer circuit is connected to the primary mixer circuit.

10. The radio transceiver as claimed in claim 1, comprising a frequency control module arranged to provide a fractional control signal to the fractional phase-locked-loop and an integer control signal to the integer phase-locked-loop.

11. The radio transceiver as claimed in claim 10, wherein the frequency control module is arranged to provide control signals to switch between the first and second modes of operation.

12. A radio transceiver for supporting multiple radio-frequency bands, the radio transceiver comprising:
a first analog front-end portion supporting a first radio-frequency band;
a second analog front-end portion supporting a second radio-frequency band;
a reference oscillator;
a fractional phase-locked-loop configured to receive a first reference signal from the reference oscillator; and
an integer phase-locked-loop;
wherein the transceiver is configured to be operable in a first mode and a second mode of operation, the first mode of operation comprising the fractional phase-locked-loop providing a first signal to the first analog front-end portion and the second mode comprising the fractional phase-locked-loop providing a second signal to the integer phase-locked loop as a second reference signal;
wherein the integer phase-locked-loop is configured to scale the second reference signal by an integer value to produce a scaled signal, and to output the scaled signal to the second analog front-end portion.

13. The radio transceiver as claims in claim 12, configured to operate in a mixed mode of operation, the mixed mode comprising the fractional phase-locked-loop providing the first signal to the first analog front-end portion, and providing the second signal to the integer phase-locked-loop for provision of the scaled signal to the second analog front-end portion.

14. The radio transceiver as claimed in claim 12, comprising a primary and a secondary mixer circuit, wherein the output of the second analog front-end portion is connected to the secondary mixer circuit and the output of the secondary mixer circuit is connected to the primary mixer circuit.

15. The radio transceiver as claimed in claim 8, comprising a frequency control module arranged to provide a fractional control signal to the fractional phase-locked-loop and an integer control signal to the integer phase-locked-loop.

16. The radio transceiver as claimed in claim 15, wherein the frequency control module is arranged to provide control signals to switch between the first and second modes of operation.
